(19) United States
(12) Patent Application Publication
(10) Pub. No.: US 2025/0368817 A1
(43) Pub. Date: Dec. 4, 2025

(54) THERMOPLASTIC RESIN COMPOSITION AND MOLDED ARTICLE THEREOF

(71) Applicant: TECHNO-UMG CO., LTD., Tokyo (JP)

(72) Inventor: Yuuki OMATA, Tokyo (JP)

(21) Appl. No.: 18/873,732

(22) PCT Filed: Jul. 26, 2023
(86) PCT No.: PCT/JP2023/027312

§ 371 Date: Dec. 11, 2024

(30) Foreign Application Priority Data
Aug. 8, 2022 (JP) 2022-126425

(51) Int. Cl. C08L 51/00; B41M 5/26; C08L 51/04

(52) U.S. Cl. CPC C08L 51/003; B41M 5/267; C08L 51/04; C08L 2205/025; C08L 2205/035

(57) ABSTRACT

A thermoplastic resin composition including a component (A) and a component (B) identified below, wherein, when a content of methyl methacrylate units is expressed as X % by mass and a content of the component (B) is expressed as Y % by mass, based on 100% by mass of a total of the component (A) and the component (B), a formula (1) identified below is satisfied.

$$0.1 < Y / ( X + Y ) < 0.9 \qquad ( 1 )$$

Component (A): An acrylic component-containing reinforced resin comprising a rubber-containing graft copolymer (a1) having a Dureau hardness (A type) of 90 or more; or an acrylic component-containing reinforced resin comprising the rubber-containing graft copolymer (a1) and a (co)polymer (a2) not containing a rubbery polymer, wherein a methyl methacrylate unit is contained in the rubber-containing graft copolymer (a1) and/or the (co)polymer (a2) Component (B): A soft elastomer having a Dureau hardness (A type) of less than 90.

### TECHNICAL FIELD

The present invention relates to a thermoplastic resin composition that can realize a molded article that has excellent laser marking properties (color development in an irradiated area) and is flexible, resulting in a good tactile feel, high grip performance having slip resistance, and has excellent optical properties. The present invention also relates to a molded article obtained by molding the thermoplastic resin composition, and an article obtained by applying laser marking to the molded article.

### BACKGROUND ART

Pad printing and silk printing using ink, and laser marking by laser irradiation are known as methods of marking a surface of a resin molded article with letters, symbols, pictures, and the like. Laser marking can be performed, for example, by the following methods (1) and (2).
(1) A method of irradiating a resin molded article that is dark in color due to a black substance with a laser, and using the energy of the laser to induce chemical changes in the resin and chemical changes in the black substance, and the like at the irradiated area, and causing the irradiated area to develop a color derived from the resin (white), and the like, to form letters, symbols, pictures, and the like (see Patent Literatures 1 and 2).
(2) A method of applying a marking composition to a surface of an article and irradiating a laser to the surface to mark it (see Patent Literature 3).

Among these, the method of Patent Literature 3 involves applying a marking composition to a surface of an article and irradiating a laser, which requires many processing steps, such as molding the molded article, applying the marking composition, and irradiating the laser, resulting in poor productivity. In addition, it is not suitable for large articles having complex shapes, such as those used in vehicles.

The thermoplastic resin composition for laser marking of Patent Literature 1 can give molded articles having excellent physical properties such as impact resistance and heat resistance, and the like, and excellent colored appearance, and by irradiating the surface with a laser, letters, symbols, pictures, and the like can be clearly expressed by the color development of the irradiated area. However, there is room for improvement in the cushioning properties, touch, and tactile feel of the obtained molded article.

Patent Literature 2 discloses a butadiene-based rubber-reinforced resin composition for laser marking that enables white color development by laser marking on transparent ABS resin. However, as with Patent Literature 1, there is room for improvement in the cushioning properties, touch, and tactile feel of the obtained molded article.

Molded articles that can be subjected to laser marking include those in a wide range of fields, such as OA equipment, home appliances, automobile parts, miscellaneous goods, building materials, and the like. Among these, OA equipment such as personal computers, printers, and the like, which are often held in the hand when used or operated; home appliances such as cameras, videos, vacuum cleaners, washing machines, and the like; and automobile interior parts such as door trims, glove boxes, and the like, which are often touched by passengers' bodies; are required to have good cushioning properties and tactile feel such as touch, while maintaining the rigidity of the parts.

However, conventional thermoplastic resin compositions for laser marking have not been able to fully satisfy the required properties in terms of cushioning properties, touch and tactile feel.

### CITATION LIST

### Patent Literature

[Patent Literature 1] JP 2012-102271 A
[Patent Literature 2] JP 2002-003548 A
[Patent Literature 3] WO 2007/072694

### SUMMARY OF INVENTION

### Technical Problem

It is an object of the present invention to provide a thermoplastic resin composition that can realize a molded article that has excellent laser marking properties (color development in an irradiated area) and is flexible, resulting in a good tactile feel, high grip performance having slip resistance, and has excellent optical properties, and to provide a molded article obtained by molding this thermoplastic resin composition, and an article obtained by applying laser marking to this molded article.

### Solution to Problem

The present inventor found that the above-described object can be achieved by a thermoplastic resin composition containing an acrylic component-containing reinforced resin (A) and a soft elastomer (B) at a specific ratio.

The gist of the present invention is as described below.

[1] A thermoplastic resin composition comprising a component (A) and a component (B) identified below,
wherein, when a content of methyl methacrylate units is expressed as X % by mass and a content of the component (B) is expressed as Y % by mass, based on 100% by mass of a total of the component (A) and the component (B), a formula (1) identified below is satisfied.

$$0.1 < Y / ( X + Y ) < 0.9 \qquad ( 1 )$$

Component (A): An acrylic component-containing reinforced resin comprising a rubber-containing graft copolymer (a1) having a Dureau hardness (A type) of 90 or more; or an acrylic component-containing reinforced resin comprising the rubber-containing graft copolymer (a1) and a (co)polymer (a2) not containing a rubbery polymer, wherein a methyl methacrylate unit is contained in the rubber-containing graft copolymer (a1) and/or the (co)polymer (a2)

Component (B): A soft elastomer having a Dureau hardness (A type) of less than 90

[2] The thermoplastic resin composition according to [1], wherein the content Y of the component (B) based on 100% by mass of the total of the component (A) and the component (B) is more than 20.0% by mass.
[3] The thermoplastic resin composition according to [1] or [2], wherein the rubber-containing graft copolymer (a1) is at least one selected from the group consisting of methyl methacrylate-acrylonitrile-butadiene-styrene graft copolymer, acrylonitrile-styrene-acrylic rubber graft copolymer, methyl methacrylate-acrylonitrile-styrene-acrylic rubber graft copolymer, and acrylonitrile-butadiene-styrene graft copolymer.
[4] The thermoplastic resin composition according to any one of [1] to [3], wherein the thermoplastic resin composition is a thermoplastic resin composition for laser marking.
[5] A molded article obtained by molding the thermoplastic resin composition according to any one of [1] to [4].
[6] An article obtained by laser marking the surface of the molded article according to [5].

### Advantageous Effects of Invention

According to the present invention, a thermoplastic resin composition that can realize a molded article that has excellent laser marking properties (color development in an irradiated area) and is flexible, resulting in a good tactile feel, high grip performance having slip resistance, and has excellent optical properties, a molded article obtained by molding this thermoplastic resin composition, and an article obtained by applying laser marking to this molded article can be provided.

### DESCRIPTION OF EMBODIMENTS

The embodiments according to the present invention will be described below in detail.

In this specification, “(co)polymer” denotes a homopolymer and/or copolymer.

“Molded article” denotes a product obtained by molding a thermoplastic resin composition.

“Unit” denotes a structural portion derived from a monomer compound before polymerization and introduced into a polymer or a copolymer. For example, “methyl methacrylate unit” denotes “structural portion derived from methyl methacrylate and introduced into a polymer or copolymer”. “Aromatic vinyl-based monomer unit” denotes “structural portion derived from an aromatic vinyl-based monomer and introduced into a polymer or a copolymer”.

“(Meth)acrylic acid” denotes one of or both “acrylic acid” and “methacrylic acid”.

### [Thermoplastic Resin Composition]

The thermoplastic resin composition of the present invention is a thermoplastic resin composition comprising a component (A) and a component (B) identified below, wherein, when a content of methyl methacrylate units is expressed as X % by mass and a content of the component (B) is expressed as Y % by mass, based on 100% by mass of a total of the component (A) and the component (B), a formula (1) identified below is satisfied. The thermoplastic resin composition of the present invention is particularly suitable as a thermoplastic resin composition for laser marking.

$$0.1 < Y / ( X + Y ) < 0.9 \qquad ( 1 )$$

Component (A): An acrylic component-containing reinforced resin comprising a rubber-containing graft copolymer (a1) having a Dureau hardness (A type) of 90 or more; or an acrylic component-containing reinforced resin comprising the rubber-containing graft copolymer (a1) and a (co)polymer (a2) not containing a rubbery polymer, wherein a methyl methacrylate unit is contained in the rubber-containing graft copolymer (a1) and/or the (co)polymer (a2) (hereinafter sometimes referred to as “acrylic component-containing reinforced resin (A)”)

Component (B): A soft elastomer having a Dureau hardness (A type) of less than 90 (hereinafter sometimes referred to as “soft elastomer (B)”)

### [Formula (1)]

The thermoplastic resin composition of the present invention satisfies the following formula (1), when a content of methyl methacrylate units is expressed as X % by mass and a content of the component (B) is expressed as Y % by mass, based on 100% by mass of a total of the above component (A) and the above component (B).

$$0.1 < Y / ( X + Y ) < 0.9 \qquad ( 1 )$$

When Y/(X+Y) is 0.1 or less, the flexibility is poor, and when Y/(X+Y) is 0.9 or more, the laser marking properties are poor. When Y/(X+Y) is greater than 0.1 and less than 0.9, that is, when the above formula (1) is satisfied, both flexibility and laser marking properties are good.

From the viewpoint of achieving both flexibility and laser marking properties, the thermoplastic resin composition of the present invention preferably satisfies the following formula (1A), and more preferably satisfies the following formula (1B).

$$0.2 ≦ Y / ( X + Y ) ≦ 0.8 \qquad ( 1 A )$$

$$0.3 ≦ Y / ( X + Y ) ≦ 0.7 \qquad ( 1 B )$$

### [Acrylic Component-Containing Reinforced Resin (A)]

The acrylic component-containing reinforced resin (A) is composed of a rubber-containing graft copolymer (a1) having a Dureau hardness (A type) of 90 or more, or the rubber-containing graft copolymer (a1) and a (co)polymer (a2) not containing a rubber polymer. The rubber-containing graft copolymer (a1) and/or the (co)polymer (a2) contain methyl methacrylate units. In other words, the content of methyl methacrylate units in 100% by mass of acrylic component-containing reinforced resin (A) is greater than 0% by mass.

<Rubber-Containing Graft Copolymer (a1)>

Examples of rubber-containing graft copolymer (a1) include methyl methacrylate-acrylonitrile-butadiene-styrene graft copolymer (MABS resin), acrylonitrile-styrene-acrylic rubber graft copolymer (ASA resin), methyl methacrylate-acrylonitrile-styrene-acrylic rubber graft copolymer (MASA resin), acrylonitrile-butadiene-styrene graft copolymer (ABS resin), methyl methacrylate-acrylic rubber-styrene graft copolymer (MSA resin), and the like.

Among these, as the rubber-containing graft copolymers (a1), methyl methacrylate-acrylonitrile-butadiene-styrene graft copolymer (MABS resin), acrylonitrile-styrene-acrylic rubber graft copolymer (ASA resin), methyl methacrylate-acrylonitrile-styrene-acrylic rubber graft copolymer (MASA resin), and acrylonitrile-butadiene-styrene graft copolymer (ABS resin) are preferred, from the viewpoint of laser marking properties, and methyl methacrylate-acrylonitrile-styrene-butadiene graft copolymer (MABS resin) and methyl methacrylate-acrylonitrile-acrylic rubber-styrene graft copolymer (MASA resin) are more preferred.

The acrylic component-containing reinforced resin (A) may contain only one type of these rubber-containing graft copolymers (a1), or may contain two or more types.

The rubber-containing graft copolymer (a1) according to the present invention can be produced preferably by graft copolymerizing a vinyl-based monomer mixture (a1-2) shown below in the presence of a rubbery polymer (a1-1) shown below.

(Rubbery Polymer (a1-1))

There is no particular limitation regarding the rubbery polymer (a1-1) constituting the rubber-containing graft copolymer (a1) used in the acrylic component-containing reinforced resin (A), and examples thereof include diene-based rubber, acrylic-based rubber, ethylene-based rubber, and the like. Specific examples include polybutadiene, poly(butadiene-styrene), poly(butadiene-acrylonitrile), polyisoprene, poly(butadiene-butyl acrylate), poly(butadiene-methyl acrylate), poly(butadiene-methyl methacrylate), poly(butadiene-ethyl acrylate), ethylene-propylene rubber, ethylene-propylene-diene rubber, poly(ethylene-isobutylene), poly(ethylene-methyl acrylate), poly(ethylene-ethyl acrylate), and the like. These rubbery polymers are used alone or in a mixture of two or more. Among these, diene-based rubber and acrylic-based rubber are particularly preferably used from the viewpoint of laser marking properties.

The volume average particle diameter of the rubbery polymer (a1-1) is preferably 90 to 1,500 nm, more preferably 150 to 1,000 nm, and even more preferably 200 to 500 nm, from the viewpoints of impact resistance, molding processability, fluidity, and appearance of the resulting thermoplastic resin composition.

Here, the volume average particle diameter of the rubbery polymer (a1-1) is measured by the method described in the Examples section below.

(Vinyl-Based Monomer Mixture (a1-2))

The vinyl-based monomer mixture (a1-2) is preferably a vinyl-based monomer mixture containing at least an aromatic vinyl-based monomer and a vinyl cyanide-based monomer, or a vinyl-based monomer mixture containing at least an (meth)acrylic acid alkyl ester-based monomer.

Examples of the aromati vinyl-based monomer include styrene, α-methylstyrene, p-methylstyrene, vinyltoluene, t-butylstyrene, o-ethylstyrene, o-chlorostyrene, and o,p-dichlorostyrene. These may be used alone, or at least two types may be used in combination.

Examples of the vinyl cyanide-based monomer include acrylonitrile, methacrylonitrile, ethacrylonitrile, and the like. Among these, acrylonitrile is particularly preferred. The vinyl cyanide-based monomers may be used alone, or at least two types may be used in combination.

In the case of a vinyl-based monomer mixture containing at least an aromatic vinyl-based monomer and a vinyl cyanide-based monomer, the ratio of the aromatic vinyl-based monomer to the vinyl cyanide-based monomer in 100% by mass of the vinyl-based monomer mixture (a1-2) is preferably aromatic vinyl-based monomer/vinyl cyanide-based monomer=50% to 95% by mass/50% to 5% by mass, more preferably 60% to 85% by mass/40% to 15% by mass, and even more preferably 65% to 80% by mass/35% to 20% by mass, from the viewpoints of moldability and appearance of molded articles.

The vinyl-based monomer mixture (a1-2), which is a vinyl-based monomer mixture containing at least an aromatic vinyl-based monomer and a vinyl cyanide-based monomer, may contain, in addition to the aromatic vinyl-based monomer and the vinyl cyanide-based monomer, another vinyl-based monomer copolymerizable with these in the range of 0% to 30% by mass. Examples of the another vinyl-based monomer copolymerizable with these include at least one of unsaturated carboxylic acid ester-based monomers such as methyl (meth)acrylate, and the like; maleimide-based monomers, such as N-methylmaleimide, N-cyclohexylmaleimide, N-phenylmaleimide, and the like; unsaturated dicarboxylic acids such as maleic acid, and the like; unsaturated dicarboxylic acid anhydrides such as maleic anhydride, and the like; and unsaturated amides such as acrylamide, and the like; however the vinyl-based monomer is not limited to these. Among these, methyl (meth)acrylate, N-phenylmaleimide, and maleic anhydride are preferable.

Examples of (meth)acrylic acid alkyl ester-based monomers include (meth)acrylic acid alkyl ester-based monomers in having alkyl group having 1 to 8 carbon atoms. Examples of (meth)acrylic acid alkyl ester-based monomers include methyl (meth)acrylate, ethyl (meth)acrylate, propyl (meth)acrylate, n-butyl (meth)acrylate, i-butyl (meth)acrylate, amyl (meth)acrylate, n-hexyl (meth)acrylate, n-octyl (meth)acrylate, 2-ethylhexyl (meth)acrylate, cyclohexyl (meth)acrylate, and the like. Among these, methyl methacrylate is preferred from the viewpoint of color development by laser marking.

The vinyl-based monomer mixture (a1-2), which is a vinyl-based monomer mixture containing at least a (meth)acrylic acid alkyl ester-based monomer, may contain, in addition to the (meth)acrylic acid alkyl ester-based monomer, another vinyl-based monomer copolymerizable with these in the range of 0% to 30% by mass. Examples of the another vinyl-based monomer copolymerizable with these include vinyl-based monomers other than (meth)acrylic acid ester-based monomers, which are mentioned above as vinyl-based monomers used in the vinyl-based monomer mixture (a1-2), which is a vinyl-based monomer mixture containing at least an aromatic vinyl-based monomer and a vinyl cyanide-based monomer.

(Proportion of Rubbery Polymer (a1-1) and Vinyl-Based Monomer Mixture (a1-2))

The graft copolymer (a1) is preferably produced by graft polymerizing 20% to 65% by mass of vinyl-based monomer mixture (a1-2) in the presence of 35% to 80% by mass of rubbery polymer (a1-1). Here, the total of the rubbery polymer (a1-1) and the vinyl-based monomer mixture (a1-2) is 100% by mass.

When the rubbery polymer (a1-1) is less than 35% by mass, and the vinyl-based monomer mixture (a1-2) is more than 65% by mass, the softness of the resulting thermoplastic resin composition is poor. When the rubbery polymer (a1-1) is more than 80% by mass, and the vinyl-based monomer mixture (a1-2) is less than 20% by mass, the optical properties of the resulting thermoplastic resin composition are reduced. The proportion of the rubbery polymer (a1-1) is preferably 45% to 78% by mass and more preferably 53% to 73% by mass. The proportion of the vinyl-based monomer mixture (a1-2) is preferably 22% to 55% by mass and more preferably 27% to 47% by mass.

### (Graft Polymerization)

There are no particular limitations on the method for producing the rubber-containing graft copolymer (a1) by graft polymerization, and it can be produced by any known method such as an emulsion polymerization method, a suspension polymerization method, a continuous bulk polymerization method, a continuous solution polymerization method, and the like. Preferably, the rubber-containing graft copolymer (a1) is produced by using an emulsion polymerization method or a bulk polymerization method. Since the emulsifier content and the amount of water in the rubber-containing graft copolymer (a1) are readily adjusted, it is most preferable to produce the rubber-containing graft copolymer (a1) by an emulsion polymerization method.

### (Graft Ratio)

The entire amount of the vinyl-based monomer mixture (a1-2) is not necessarily grafted, and the rubber-containing graft copolymer (a1) obtained as a mixture with a copolymer that is not grafted is used usually. This mixture is essentially a composition but is included in the rubber-containing graft copolymer (a1) in the present invention.

There is no particular limitation regarding the graft rate of the rubber-containing graft copolymer (a1), but, from the viewpoint of the impact resistance of the resulting thermoplastic resin composition, the graft rate is preferably 20% to 100% by mass, more preferably 30% to 80% by mass, and even more preferably 40% to 70% by mass.

The graft ratio of the rubber-containing graft copolymer (a1) is measured by the method described in the Examples section below.

### (Duro Hardness (Type A))

The rubber-containing graft copolymer (a1) used in the present invention must have a Dureau hardness (Type A) of 90 or more. When the rubber-containing graft copolymer (a1) has a Dureau hardness (Type A) of less than 90, it is not preferable from the viewpoints of molding processability and fluidity. From the viewpoints of softness, molding processability, and fluidity, it is preferable that the rubber-containing graft copolymer (a1) has a Dureau hardness (Type A) of 90 or more.

The Dureau hardness (Type A) of the rubber-containing graft copolymer (a1) is measured by the method described in the Examples section below.

<(Co)Polymer (a2)>

Examples of the (co)polymer (a2) not containing a rubber polymer used in the acrylic component-containing reinforced resin (A) include styrene-based resins such as acrylonitrile-styrene copolymer (AS), methyl acrylate-acrylonitrile-styrene copolymer (MAS), and the like, and polyacrylic resins, and the like. These (co)polymers (a2) may be used alone or in combination of two or more.

### (Styrene-Based Resin)

The mass average molecular weight (Mw) of the styrene-based resin is preferably 50,000 to 400,000, more preferably 70,000 to 350,000, and even more preferably 90,000 to 300,000. The molecular weight distribution (Mw/Mn) is preferably 1.3 to 2.8, more preferably 1.8 to 2.6, and even more preferably 1.9 to 2.4.

The mass average molecular weight and molecular weight distribution of the styrene-based resin can be measured as values in terms of polystyrene on the basis of GPC (gel permeation chromatography).

The styrene-based resins may be used alone, or at least two types of styrene-based resins that differ from each other in monomer composition, molecular weight, or the like may be used in combination.

In the styrene-based resins, the ratio of the aromatic vinyl-based monomer unit to the vinyl cyanide-based monomer unit in 100% by mass of the acrylonitrile-styrene-based resin is preferably aromatic vinyl-based monomer unit/vinyl cyanide-based monomer unit=50% to 95% by mass/50% to 5% by mass, more preferably 60% to 85% by mass/40% to 15% by mass, and even more preferably 65% to 80% by mass/35% to 20% by mass from the viewpoint of the moldability and the molded article appearance.

When the total content of the three types of structural units in the methyl acrylate-acrylonitrile-styrene copolymer is taken as 100% by mass, the content of the structural units derived from aromatic vinyl compounds is preferably 5% to 50% by mass, and more preferably 15% to 25% by mass, the content of the structural units derived from vinyl cyanide compounds is preferably 4% to 25% by mass, and more preferably 5% to 15% by mass, and the content of the structural units derived from methyl acrylate is preferably 55% to 80% by mass, and more preferably 60% to 75% by mass.

### <Polyacrylic Resin>

The polyacrylic resin is obtained by polymerizing a vinyl-based monomer or a vinyl-based monomer mixture containing (meth)acrylic acid ester-based monomer by using a known method. The vinyl-based monomer mixture contains a (meth)acrylic acid ester-based monomer as an indispensable component and, as the situation demands, may contain other vinyl-based monomers described below within the range of 40% by mass.

Examples of the (meth)acrylic acid ester-based monomer include methyl (meth)acrylate, ethyl (meth)acrylate, n-propyl (meth)acrylate, i-propyl (meth)acrylate, n-butyl (meth)acrylate, i-butyl (meth)acrylate, t-butyl (meth)acrylate, phenyl (meth)acrylate, and the like.

Examples of the vinyl-based monomer other than the (meth)acrylic acid ester-based monomer include aromatic vinyl-based monomers, vinyl cyanide-based monomers, maleimide-based monomers, (meth)acrylic acid, and the like. Regarding the aromatic vinyl-based monomer and the vinyl cyanide-based monomer, monomers akin to that contained in the vinyl-based monomer mixture (a1-2) can be used.

Examples of the maleimide-based monomer include N-alkylmaleimides (N-methylmaleimide, N-ethylmaleimide, N-n-propylmaleimide, N-i-propylmaleimide, N-n-butylmaleimide, N-i-butylmaleimide, N-t-butylmaleimide, and the like), N-cycloalkylmaleimides (N-cyclohexylmaleimide and the like), N-arylmaleimides (N-phenylmaleimide, N-alkyl-substituted phenylmaleimide, N-chlorophenylmaleimide, and the like), and the like.

Of the polyacrylic resins, specific examples of the copolymerization resins of methyl methacrylate and methyl acrylate include commercially available “PARAPET (registered trademark) G” manufactured by Kuraray Co., Ltd., “ACRYPET (registered trademark) VH” and “ACRYPET (registered trademark) MD” manufactured by Mitsubishi Chemical Corporation, and the like. Specific examples of polyacrylic resins containing both the (meth)acrylic acid ester-based monomer unit and the maleimide-based monomer unit include commercially available “PARAPET (registered trademark) SH-N” manufactured by Kuraray Co., Ltd., “POLYIMILEX (registered trademark) PML203” produced by NIPPON SHOKUBAI CO., LTD., and the like.

These polyacrylic resins may be used alone or in combination of two or more types.

<Ratio of Rubber-Containing Graft Copolymer (a1) and (Co)Polymer (a2)>

The acrylic component-containing reinforced resin (A) may consist of only the rubber-containing graft copolymer (a1) described above, or may consist of the rubber-containing graft copolymer (a1) and the (co)polymer (a2). In either case, the rubber-containing graft copolymer (a1) or the rubber-containing graft copolymer (a1) and the (co)polymer (a2) are used as the acrylic component-containing reinforced resin (A) so as to satisfy the above mentioned formula (1), and more preferably so as to satisfy the preferred methyl methacrylate unit content of the acrylic component-containing reinforced resin (A) described below, and the preferred rubbery polymer (a1-1) content of the thermoplastic resin composition of the present invention described below.

### <Methyl Methacrylate Unit Content>

The acrylic component-containing reinforced resin (A) contains methyl methacrylate units because the rubber-containing graft copolymer (a1) and/or (co)polymer (a2) constituting the acrylic component-containing reinforced resin (A) contain methyl methacrylate units.

The content of methyl methacrylate units in the acrylic component-containing reinforced resin (A) is not particularly limited as long as it satisfies the above formula (1), but it is preferable that the content is 8.0% to 75.0% by mass, and particularly 8.5% to 73.5% by mass, because it is easy to satisfy the above formula (1) while ensuring a suitable content of the soft elastomer (B) in the thermoplastic resin composition.

### [Soft Elastomer (B)]

The soft elastomer (B) contained in the thermoplastic resin composition of the present invention has a Dureau hardness (A type) of less than 90. There is no particular limitation regarding the soft elastomer (B) as long as it is a polymer that can produce a molded article having rubber elasticity by molding through heat-melting. The soft elastomer (B) can be molded through heat-melting, but the diene-based rubber-containing graft copolymer and the non-diene-based rubber-containing graft copolymer used as the rubber-containing graft copolymer (a1) can not be molded through heat-melting. Therefore, these differ from each other.

The soft elastomer (B) has a Dureau hardness (type A) of less than 90. When the soft elastomer (B) has a Dureau hardness (type A) of 90 or more, softness is not obtained. However, when the soft elastomer (B) has an excessively small Dureau hardness (type A), it is not preferable from the viewpoint of molding processability and flowability. The soft elastomer (B) has a Dureau hardness (type A) of preferably 20 or more and less than 90, more preferably 40 to 80.

Specific examples of the soft elastomer (B) include acrylic elastomers, styrene-based elastomers, diene-based elastomers such as polybutadiene-based elastomers and the like, olefin-based elastomers, urethane-based elastomers, polyvinylchloride-based elastomers, ester-based elastomers, fluororesin-based elastomers, ion-crosslinked elastomers (ionomers), and the like.

Specific examples of acrylic elastomers include soft acrylic resins.

Commercially available soft acrylic resins may be used, and specific examples include the Trizect series (product name, manufactured by ARONKASEI CO., LTD.), the Clarity (registered trademark) series (product name, manufactured by Kuraray Co., Ltd.), the Parapet (registered trademark) series (product name, manufactured by Kuraray Co., Ltd.), and the like.

Specific examples of the styrene-based elastomer include block copolymers containing at least one polymer block P of an aromatic vinyl compound and at least one polymer block Q of a conjugated diene compound and hydrogenation products thereof. The polymer block P and the polymer block Q may be bonded in a straight chain type or may be bonded in a radial type. The polymer block Q may be a random copolymer containing a small amount of aromatic vinyl compound as a constituent unit or may be a so-called taper-type block in which the content of the constituent unit derived from an aromatic vinyl compound gradually increases.

There is no particular limitation regarding the structure of the block copolymer, and any one of (P-Q)n type, (P-Q)n-P type, and (P-Q)n-C type can be adopted.

Here, P represents a polymer block of an aromatic vinyl compound, Q represents a polymer block of a conjugated diene compound, C represents a coupling agent residue, and n represents an integer of 1 or more.

Regarding the aromatic vinyl compound serving as the constituent unit of the polymer block P of the styrene-based elastomer, all aromatic vinyl monomers listed as contained in the vinyl-based monomer mixture (a1-2) above may be used, and styrene is preferably used. These aromatic vinyl compounds can be used alone or in combination of two or more.

Examples of the conjugated diene compound serving as the constituent unit of the polymer block Q of the styrene-based elastomer include 1,3-butadiene, isoprene, 2-methyl-1,3-butadiene, 2,3-diethyl-1,3-butadiene, 2-neopentyl-1,3-butadiene, 2-chloro-1,3-butadiene, 2-cyano-1,3-butadiene, substituted straight-chain conjugated pentadienes, straight-chain or side-chain conjugated hexadienes, and the like. Among these, 1,3-butadiene, isoprene, and 2-methyl-1,3-butadiene are preferable. These conjugated diene compounds can be used alone or in combination of two or more.

The content of the polymer block P of the styrene-based elastomer is preferably 5% to 60% by mass and more preferably 15% to 50% by mass. The content of the polymer block Q is preferably 95% to 40% by mass and more preferably 85% to 50% by mass. When the contents of the polymer blocks P and Q are within the above-described ranges, the touch feeling (grip feeling) and the slip resistance of the molded article using the obtained thermoplastic resin composition are favorable.

The styrene-based elastomer that is not hydrogenated and that is composed of the above-described block copolymer can be produced through block copolymerization by using a common method. The hydrogenated product of the block copolymer can be obtained by subjecting the polymer block Q of the conjugated diene compound of the block copolymer thus obtained to a hydrogenation reaction by using a known method. Specific methods include methods described in JP S42-8704 B, JP S43-6636 B, JP S63-4841 B, JP S63-5401 B, JP H2-133406 A, and JP H1-297413 A.

Regarding the hydrogenation reaction, when the conjugated-diene-based polymer in which the polymer block Q is a polymer block of 1,3-butadiene is nonselectively hydrogenated, ethylene is generated from a portion polymerized through 1,4-vinyl bonding, and butylene is generated from a portion polymerized through 1,2-vinyl bonding, so that a styrene-ethylene-butylene-styrene copolymer (SEBS) and the like are generated as hydrogenation products. On the other hand, when a 1,2-vinyl bond is selectively hydrogenated, a styrene-butadiene-butylene-styrene copolymer (SBBS) and the like are generated as hydrogenation products.

Preferable examples of the above mentioned styrene-based elastomer include a styrene-butadiene-styrene block copolymer (SBS), a styrene-ethylene-butylene-styrene copolymer (SEBS), a styrene-butadiene-butylene-styrene copolymer (SBBS), and a styrene-isoprene-styrene copolymer (SIS). Of these, in particular, a styrene-ethylene-butylene-styrene copolymer (SEBS) is favorable from the viewpoint of the touch feeling (grip feeling) and the slip resistance.

Commercially available products may be used as styrene-ethylene-butylene-styrene copolymer (SEBS). Specific examples of the commercially available product include the DYNARON (registered trademark) Series (trade name, manufactured by JSR Corporation), the RABALON (registered trademark) Series (trade name, manufactured by Mitsubishi Chemical Corporation), the Tuftec (registered trademark) Series (trade name, manufactured by Asahi Kasei Corporation), the TPE-SB (trade name, manufactured by Sumitomo Chemical Co., Ltd.) Series, and the like.

Examples of the soft elastomers (B) other than acrylic elastomers and styrene-based elastomers include high cis- and low cis-butadiene rubber (BR), high cis-isoprene rubber (IR), emulsification polymerization and solution polymerization styrene-butadiene rubber (SBR), acrylonitrile-butadiene rubber (NBR), ethylene-propylene rubber (EPM, EPDM), chloroprene rubber, butyl rubber, natural rubber (NR), and the like.

Only one type of the soft elastomer (B), such as an acrylic elastomer or a styrene-based elastomer, may be used, or two or more types that differ from each other in elastomer species, structure, constituent unit, physical properties, or the like may be used in combination.

### [Content Ratio of Component (A) and Component (B)]

The thermoplastic resin composition of the present invention contains less than 95.0% by mass, preferably 50% by mass or more and less than 80.0% by mass, more preferably 55.0% to 79.9% by mass of the component (A) based on 100% by mass of the total of the component (A) and the component (B), and contains more than 5% by mass, preferably more than 20% by mass and 50% by mass or less, and more preferably 21.1% to 45.0% by mass of the component (B). That is, Y in the above mentioned formula (1) is more than 5% by mass, preferably more than 20% by mass and 50% by mass or less, and more preferably 21.1% to 45.0% by mass.

When the content ratio of the component (A) and the component (B) is within the above range, it is possible to achieve a high degree of both laser markability and softness. Of these, with regard to softness, the average friction MIU value (grip feeling), Duro hardness type D, and flexural modulus (softness) are all good.

[Rubbery Polymer (a1-1) Content]

The thermoplastic resin composition of the present invention preferably contains 2% to 35% by mass, particularly 5% to 35% by mass, and especially 8% to 33% by mass of the rubbery polymer (a1-1) derived from the rubber-containing graft copolymer (a1) based on 100% by mass of the thermoplastic resin composition. When the content of the rubbery polymer (a1-1) in the thermoplastic resin composition is equal to or higher than the above lower limit, the touch feeling (grip performance), slip resistance, and softness are good, and when the content is equal to or lower than the above upper limit, the optical properties are good.

### [Methyl Methacrylate Unit Content]

The thermoplastic resin composition of the present invention contains preferably more than 2.0% by mass, more preferably 5.0% to 70.0% by mass, even more preferably 13.5% to 70.0% by mass of the methyl methacrylate unit derived from the component (A) based on 100% by mass of the total of the component (A) and the component (B). That is, X in the above mentioned formula (1) is preferably more than 2.0% by mass, more preferably 5.0% to 70.0% by mass, and even more preferably 13.5% to 70.0% by mass. When the content of methyl methacrylate units in the thermoplastic resin composition is within the above range, the color development (sharpness and visibility) of the irradiated area in laser marking will be good.

### [Inorganic Compound (D)]

The thermoplastic resin composition of the present invention has improved moldability by containing an inorganic compound (D). In addition, the shape of the molded article obtained can be stabilized by containing an inorganic compound (D).

Examples of the inorganic compound (D) include metal fiber, aramid fiber, asbest, potassium titanate whisker, wollastonite, glass flake, glass beads, talc, mica, clay, calcium carbonate, barium sulfate, titanium oxide, aluminum oxide, and the like.

The shape of the inorganic compound (D) is preferably flat-plate-like, linear, or scale-like. Of these, a plate-like shape or a scale-like shape is more preferable from the viewpoint of the appearance of the resulting molded article.

A volume average particle diameter determined by a laser diffraction method of the inorganic compound (D) is preferably 1 to 200 μm. The volume average particle diameter is more preferably 2 to 120 μm, even more preferably 10 to 80 μm, and particularly preferably 15 to 40 μm. When the volume average particle diameter of the inorganic compound (D) is equal to or more than the above lower limit, a good balance between moldability and softness will be achieved, and when it is equal to or less than the above upper limit, good optical properties will be achieved.

The ratio (aspect ratio) of the thickness to the volume average particle diameter of the inorganic compound (D) is preferably 5 to 150, more preferably 10 to 120, and even more preferably 40 to 90. When the aspect ratio is equal to or more than the above lower limit, the balance between moldability and softness is good, and when it is equal to or less than the upper limit, the touch feeling (grip performance) and slip resistance are good.

Only one type of the inorganic compound (D) may be used, or two or more types that differ from each other in materials, shapes, and the like may be used in combination.

Among the inorganic compounds (D), titanium oxide, talc, mica, and calcium carbonate are preferred, and mica is particularly preferred from the viewpoint of appearance.

Mica include dry-ground mica and wet-ground mica, and wet-ground mica is preferable. In particular, wet-ground muscovite is preferable. This is because wet-ground mica has higher utility value than dry-ground mica due to high purity and no influence being exerted on the appearance.

When the thermoplastic resin composition of the present invention contains the inorganic compound (D), the content of the inorganic compound (D) is preferably 0% to 10% by mass, more preferably 0.5% to 5.5% by mass, and even more preferably 3% to 15% by mass, based on 100% by mass of the total of the component (A) and the component (B). When the content of the inorganic compound (D) is equal to or more than the above lower limit, the above mentioned effect of using the inorganic compound (D) can be sufficiently obtained, and when it is equal to or less than the above upper limit, the mechanical properties and the appearance of the molded article are not impaired.

### [Other Additives]

To improve the performance as a forming resin, various additives may be added to the thermoplastic resin composition according to the present invention within the bound of not impairing the object of the present invention.

Examples of other additive include antioxidants such as hindered phenol base, sulfur-containing organic compound base, phosphorus-containing organic compound base, and the like; various stabilizers such as heat stabilizers such as phenol base, acrylate base, and the like, transesterification inhibitors such as a mixture of monostearyl acid phosphate and distearyl acid phosphate, and the like, ultraviolet absorbers such as benzotriazole base, benzophenone base, salicylate base, and the like, and light stabilizers such as organic nickel base, hindered amine base, and the like; lubricants such as higher fatty acid metal salts, higher fatty acid amides, and the like; plasticizers such as phthalic acid esters, phosphoric acid esters, and the like; flame retardants and flame retardant auxiliaries such as halogen-containing compounds such as polybromodiphenyl ether, tetrabromobisphenol A, brominated epoxy oligomers, brominated polycarbonate oligomers, and the like, phosphorus-based compounds, antimony trioxide, and the like; and carbon black, pigments, dyes, and the like.

Among these, by blending about 0.001 to 5 parts by mass of carbon black having a particle diameter of about 10 to 80 nm based on 100 parts by mass of the total of the component (A) and the component (B), the color development and visibility by laser marking are excellent.

### [Method for Producing Thermoplastic Resin Composition]

The thermoplastic resin composition of to the present invention may be produced by using various methods, including a method in which, the above mentioned components (A) and (B) and inorganic compound (D) and the above mentioned additives which are used as the situation demands are melt-kneaded by using a Banbury mixer, a roll, or a single-screw or multi-screw extruder.

### [Molded Article]

The molded article of the present invention is obtained by molding the thermoplastic resin composition of to the present invention by using a known forming method. Examples of the molding method include an injection molding method, a press molding method, an extrusion molding method, a vacuum forming method, a blow molding method, and the like.

The molded article of the present invention obtained by molding the thermoplastic resin composition of the present invention has excellent laser marking properties (color development in the irradiated area), slip resistance, and high grip performance. Therefore, the molded article of the present invention is used not only as a grip surface but also as a part of a housing of electric or electronic components, automobile components, machine mechanism components, OA equipment, housing components of home electric appliances, general merchandise, housing construction materials, and the like, and laser marking is possible on the surface.

### [Article]

The article of the present invention is obtained by subjecting the molded article of the present invention, which is obtained by molding the thermoplastic resin composition of the present invention, to laser marking.

Examples of the laser used for laser marking include gas lasers such as He—Ne laser, Ar laser, CO₂ laser, excimer laser, and the like; solid lasers such as YAG laser, and the like; semiconductor laser; dye laser, and the like. In the present invention, CO₂ laser, excimer laser, YAG laser, and the like are preferably used.

### EXAMPLE

The present invention will be explained in more detail below with Examples and Comparative Examples. The present invention is not limited to the following Examples as long as it does not exceed the gist of the present invention.

“%” expresses % by mass, and “part” expresses part by mass, unless otherwise specified.

### [Measurement Method]

The volume average particle diameter of the rubbery polymer (a1-1), the graft ratio of the rubber-containing graft copolymer (a1), the Dureau hardness (A type) of the rubber-containing graft copolymer (a1) and the soft elastomer (B), and the methyl methacrylate unit content (referred to as “MMA content” in Tables 1A and 1B) of the rubber-containing graft copolymer (a1), the (co)polymer (a2) and the like were measured by the following (1) to (4) respectively.

### (1) Volume Average Particle Diameter

The volume average particle diameter of the rubbery polymer (a1-1) in a latex was measured at room temperature by using “Microtrac UPA150” (trade name) manufactured by HONEYWELL. The unit is nm.

It is known that there is substantially no difference between the latex particle diameter of the rubbery polymer (a1) and the rubber particle diameter of the rubbery polymer (a1) in the resin composition by using the rubbery polymer (a1), and the former is in accord with the latter.

### (2) Graft Rate

The graft rate of the rubber-containing graft copolymer (a1) is calculated on the basis of a formula below.

$$graft rate ( \% by mass ) = \{ [ ( n ) - ( m ) \times L ] / [ ( m ) \times L ] \} \times 100$$

In the above-described formula, n represents mass (g) of acetone-insoluble matters obtained by placing about 1 g [weighing capacity: m (g)] of the rubber-containing graft copolymer (a1) into 20 ml of acetone, performing shaking for 2 hours by using a shaker under a temperature condition of 25° C., and performing centrifugal separation for 60 minutes by using a centrifuge (rotational speed: 23,000 rpm) under a temperature condition of 5° C. so as to separate acetone-insoluble matters and acetone-soluble matters from each other.

L represents the mass (g) of the rubbery polymer (a1-1) contained in the rubber-containing graft copolymer (a1).

The mass of the rubbery polymer (a1-1) may be determined by using a method for calculating from the polymerization prescription and the degree of polymerization conversion, a method for determining based on the infrared absorption spectrum, or the like.

### (3) Duro Hardness (Type A)

Measured according to JIS K6301 Type A.

### (4) Methyl Methacrylate Unit Content

Apparatus used: Pyrolysis gas chromatograph GC7890 manufactured by Agilent Technologies

Measuring method: As a pretreatment, acetone solvent was added and centrifuged twice at 19,000 rpm for 30 minutes in a centrifuge. Then ethanol solvent was added and extraction was performed at 90° C. for 4 hours, followed by cooling and filtration. Gas chromatography analysis was performed using this filtrate.

The methyl methacrylate unit content in the acrylic component-containing reinforced resin (A) and the thermoplastic resin composition was calculated by proportional calculation from the methyl methacrylate unit content and blending ratio of the components used.

### [Acrylic Component-Containing Reinforced Resin (A)]

As the rubber-containing graft copolymer (a1), the diene-based rubber-containing graft copolymers (MABS and ABS) and the acrylic rubber-containing graft copolymers (MASA and ASA) obtained in Synthesis Examples 1 to 4 below were used.

As the (co)polymer (a2), the styrene-acrylonitrile copolymer (AS) obtained in Synthesis Example 5 below, the styrene-acrylonitrile-methyl methacrylate copolymer (MAS) obtained in Synthesis Example 6 below, and the commercially available polyacrylic resin (PMMA) shown below were used.

### Synthesis Example 1: Production of MABS

In a 10 L glass flask equipped with a stirrer, 45 parts (in terms of solid contents) of polybutadiene latex having a volume average particle diameter of 300 nm, 0.3 parts of sodium dodecylbenzenesulfonate, and 100 parts of ion-exchanged water were charged, and then 3 parts of styrene, 2 parts of acrylonitrile, and 9 parts of methyl methacrylate were charged therein to prepare a mixture. The mixture was heated to 43° C. while stirring, and then an aqueous solution consisting of 0.02 parts of sodium ethylenediaminetetraacetate, 0.001 parts of ferrous sulfate heptahydrate, 0.08 parts of sodium formaldehyde sulfoxylate dihydrate, and 6 parts of ion-exchanged water, as well as 0.04 parts of cumene hydroperoxide, was added, and the reaction was continued for 1 hour.

Then, a monomer mixture consisting of 9 parts of styrene, 5 parts of acrylonitrile, 27 parts of methyl methacrylate, 1.2 parts of t-dodecyl mercaptan, and 0.1 parts of cumene hydroperoxide, and an aqueous solution consisting of 0.01 parts of sodium ethylenediaminetetraacetate, 0.001 parts of ferrous sulfate heptahydrate, 0.05 parts of sodium formaldehyde sulfoxylate dihydrate, 0.3 parts of sodium dodecylbenzenesulfonate, and 30 parts of ion-exchanged water were added continuously over a period of 4 hours to continue the polymerization reaction.

After the addition was completed, 0.003 parts of sodium ethylenediaminetetraacetate, 0.0002 parts of ferrous sulfate, 0.01 parts of sodium formaldehyde sulfoxylate dihydrate, 0.02 parts of cumene hydroperoxide, and 1 part of ion-exchanged water were added, and the mixture was stirred for another one hour, after which it was cooled to terminate the reaction.

Then, 0.67 parts of the reaction product of p-cresol-dicyclopentadiene-isobutylene (“SANDWIN-45” manufactured by Toho Chemical Industry Co., Ltd.) and 0.5 parts of sodium ethylenediaminetetraacetate were added to the reaction product, which was then coagulated with magnesium sulfate. The reaction product was thoroughly washed with water, dehydrated, and then dried at 80° C. for 24 hours to obtain a white powder of rubber-containing graft copolymer (MABS).

The polymerization conversion rate of this MABS was 97.0%, the rubber content was 45%, the graft rate was 60%, the intrinsic viscosity [η] was 0.24 dl/g (measured in methyl ethyl ketone at 30° C.), and the Durow hardness (A type) was 90 or more.

The methyl methacrylate unit content of this MABS was 39%.

### Synthesis Example 2: Production of ABS

An interior of a reactor was replaced with nitrogen, and 120 parts of pure water, 0.5 parts of glucose, 0.5 parts of sodium pyrophosphate, 0.005 parts of ferrous sulfate, and 60 parts (in terms of solid contents) of polybutadiene latex having a volume average particle diameter of 280 nm were charged, and the temperature in the reactor was increased to 65° C. while agitation was performed. The point in time of the internal temperature reaching 65° C. was assumed to be the start of polymerization, and 30 parts of styrene, 10 parts of acrylonitrile, and 0.02 parts of a chain transfer agent, t-dodecylmercaptan mixture, were continuously added over 5 hours. Simultaneously, an aqueous solution consisting of 0.2 parts of cumene hydroperoxide, 2 parts of potassium oleate, and 20 parts of water was continuously added as a polymerization initiator over 7 hours so as to complete a reaction. The resulting latex was mixed with 1 part of 2,2′-methylenebis(4-methyl-6-t-butylphenol) relative to 100 parts of latex solid contents. Subsequently, the latex was solidified with sulfuric acid, neutralized with sodium hydroxide, washed, filtered, and dried so as to obtain a powder-like ABS.

This ABS had a rubber content of 60%, a graft rate of 52%, and a Durow hardness (A type) of 90 or more.

This ABS does not contain methyl methacrylate units.

### Synthesis Example 3: Production of MASA

MASA was produced by the following steps (i) to (ii).

### (i) Production of Acrylic Rubber Polymer Latex

A 5 L glass reactor equipped with a stirrer, a raw material and auxiliary agent adding device, a thermometer, a heating device, and the like was charged with 150 parts of water, 2 parts of sodium dodecylbenzenesulfonate as an emulsifier, 50 parts of n-butyl acrylate (hereinafter abbreviated as BA), and 1 part of allyl methacrylate, and the internal temperature was raised to 60° C. under a nitrogen stream while stirring.

When the temperature reached 60° C., 0.01 parts of cumene hydroperoxide and an aqueous solution of 0.004 parts of tetrasodium ethylenediaminetetraacetate dihydrate, 0.15 parts of sodium formaldehyde sulfoxylate, and 0.001 parts of ferrous sulfate dissolved in 10 parts of water were charged into the reactor, and polymerization was initiated at the same temperature.

One hour after the start of polymerization, the internal temperature of the reactor was maintained at 75° C. for 30 minutes, the polymerization reaction was terminated, and an acrylic rubber polymer latex was obtained. The polymerization conversion rate at this time was 97%. The volume average particle diameter of the obtained acrylic rubber was 95 nm.

### (ii) Production of Rubber-Containing Graft Polymer

20 parts of methyl methacrylate and 0.2 parts of t-dodecyl mercaptan were mixed to prepare a monomer mixture (I). 50 parts of the above acrylic rubber polymer latex (in terms of solid contents), 10 parts of water, and 0.1 parts of sodium dodecylbenzenesulfonate were charged into a 5 L glass reactor equipped with a stirrer, a raw material and auxiliary agent adding device, a thermometer, a heating device, and the like, and the temperature was raised to 65° C. under a nitrogen stream while stirring. When the temperature reached 65° C., an aqueous solution of 0.004 parts of tetrasodium ethylenediaminetetraacetate dihydrate, 0.15 parts of sodium formaldehyde sulfoxylate, and 0.001 parts of ferrous sulfate dissolved in 20 parts of water, an aqueous solution of 0.4 parts of t-butyl hydroperoxide dissolved in 40 parts of water, and the monomer mixture (I) were continuously added over a period of 3 hours to initiate polymerization. The temperature was raised to 70° C. from the start of polymerization and then maintained at 70° C. After the continuous addition was completed, the temperature was maintained for 60 minutes, then polymerization was terminated. The copolymer latex was coagulated, washed with water, and dried to obtain powder-like MASA.

This MASA had a rubber content of 50%, a graft ratio of 70%, and a Durow hardness (A type) of 90 or more.

The methyl methacrylate unit content of this MASA was 19%.

### Synthesis Example 4: Production of ASA

ASA was obtained in the same manner as in the production of MASA in Synthesis Example 3, except that a monomer mixture (II) prepared by mixing 38 parts of styrene, 12 parts of acrylonitrile, and 0.2 parts of t-dodecyl mercaptan was used instead of the monomer mixture (I).

This ASA had a rubber content of 51%, a graft ratio of 85%, and a Dureau hardness (A type) of 90 or more.

This ASA does not contain methyl methacrylate units.

### Synthesis Example 5: Production of AS

An interior of a reactor was replaced with nitrogen, and 120 parts of water, 0.002 parts of sodium alkylbenzenesulfonate, 0.5 parts of polyvinyl alcohol, 0.3 parts of azoisobutyronitrile, 0.5 parts of t-dodecylmercaptan, and a monomer mixture composed of 26 parts of acrylonitrile and 74 parts of styrene were used, and the temperature was increased for 5 hours from a start temperature of 60° C. by heating while a portion of styrene was successively added so as to reach 120° C. Further, the reaction was performed at 120° C. for 4 hours. Thereafter, polymerized material was separated so as to obtain an acrylonitrile-styrene copolymer (AS) in which acrylonitrile/styrene=26/74 (mass ratio).

The mass average molecular weight (Mw) and the molecular weight distribution (Mw/Mn) of the obtained AS in terms of polystyrene were measured by using GPC (GPC: “GPC/V2000” manufactured by Waters, column: “Shodex AT-G+AT-806 MS” manufactured by SHOWA DENKO K. K.) and using o-dichlorobenzene (145° C.) as a solvent. As a result, the mass average molecular weight (Mw) was 110,000, and the molecular weight distribution (Mw/Mn) was 2.3.

This AS does not contain methyl methacrylate units.

### Synthesis Example 6: Production of MAS

A monomer mixture was prepared by mixing 21 parts of styrene, 7 parts of acrylonitrile, 72 parts of methyl methacrylate, 0.3 parts of t-dodecyl mercaptan, and 0.2 parts of diisopropylbenzene hydroperoxide.

A 10-liter glass reactor equipped with a stirrer, a raw material and auxiliary agent addition device, a thermometer, a heating device, and the like was charged with 150 parts of water and 2 parts of sodium dodecylbenzenesulfonate as an emulsifier, and the internal temperature was raised to 55° C. under a nitrogen gas flow while stirring. When the temperature reached 55° C., the above monomer mixture and an aqueous solution of 0.09 parts of tetrasodium ethylenediaminetetraacetate dihydrate, 0.003 parts of ferrous sulfate heptahydrate, and 0.2 parts of sodium formaldehyde sulfoxylate dissolved in 24 parts of water were added continuously for 5 hours.

The internal temperature was raised to 67° C. within 1 hour from the start of the monomer mixture addition, and was then maintained at 67° C. After the continuous addition was completed, 0.05 parts of diisopropylbenzene hydroperoxide was added, and the internal temperature was maintained for another one hour to terminate the polymerization reaction. This copolymer latex was coagulated using calcium chloride, washed with water, and dried to obtain a powder-like copolymer (MAS).

The polymerization conversion rate at this time was 98%, and the intrinsic viscosity [η] was 0.33 dl/g (measured at 30° C. in methyl ethyl ketone).

The methyl methacrylate unit content of this MAS was 71%.

### <PMMA>

Regarding a polyacrylic resin, PMMA “ACRYPET (registered trademark) VH5” (methyl methacrylate unit content: 99.5%) manufactured by Mitsubishi Chemical Corporation was used.

### [Soft Elastomer (B)]

The following commercially available products were used as the soft elastomer (B).

Styrene-based elastomer: Hydrogenated block copolymer SEBS “Dynaron (registered trademark) DR8903P” (Duro hardness (A type): 49) manufactured by JSR Corporation Acrylic elastomer: Soft acrylic resin “Parapet (registered trademark) SA-FW001” (Duro hardness (A type): 70, methyl methacrylate unit content: 34%) manufactured by Kuraray Co., Ltd.

### Examples 1-9 and Comparative Examples 1-4

### <Production of Thermoplastic Resin Composition for Physical Property Measurement and Evaluation>

The components described in Tables 1A and 1B below were mixed in the mixing ratios described in Tables 1A and 1B. Then, 0.2 parts of “ADEKA STAB (registered trademark) A-60” (tetrakis [methylene-3-(3′,5′-di-t-butyl-4′-hydroxyphenyl) propionate] methane) manufactured by ADEKA Corporation was added, and the mixture was melt-kneaded at a barrel temperature of 220° C. using a Twin Screw Extruder (model name “TEX44”, manufactured by Japan Steel Works, Ltd.) and pelletized. Molded articles (1) to (4) below were produced by using the resulting thermoplastic resin composition pellet and were subjected to the measurement and the evaluation below. The results are described in Tables 1A and 1B.

### <Production of Molded Article (1)>

A test piece of 120 mm×80 mm×2 mm was molded by using an injection molding machine “IS100GN” (trade name) manufactured by TOSHIBA MACHINE CO., LTD. under the conditions of a resin temperature of 220° C., a mold temperature of 50° C., an injection rate of 40 mm/s, and an injection pressure of 100 MPa. A mold having a leather-like grained inner surface (grain No.: TH-894) having unevenness (the depth of a recessed portion was 100 μm) was used as a mold for molding.

### <Production of Molded Article (2)>

A dumbbell test piece (without weld) having a gate on one side was molded by using an injection molding machine “J110AD-180H” (Model name) manufactured by Japan Steel Works, Ltd., while the cylinder temperature was set to be 220° C., and the mold temperature was set to be 50° C. Subsequently, a test piece (size: 80×10×4 mm) without a weld was produced by cutting out out of the central portion of the molded dumbbell test piece.

### <Production of Molded Article (3)>

A dumbbell test piece with a weld at the center thereof was produced by using a mold having a gate at both ends of the mold so that the weld was formed at the center of the dumbbell test piece, and the injection molding machine “J110AD-180H” (Model name) manufactured by Japan Steel Works, Ltd. The cylinder temperature was set to be 220° C., and the mold temperature was set to be 50° C. Subsequently, a test piece (size: 80×10×4 mm) with the weld at the central portion thereof was produced by cutting out of the central portion of the molded dumbbell test piece with the weld at the central portion.

### <Production of Molded Article (4)>

A test piece (size: 80×10×4 mm) having a gate on one side was produced by using the injection molding machine “J110AD-180H” (Model name) manufactured by Japan Steel Works, Ltd. The cylinder temperature was set to be 220° C., and the mold temperature was set to be 50° C.

### <Measurement of MIU Value (KES Texture Measurement)>

The MIU value of the grained surface of the molded article (1) was measured using the “Friction Tester KES-SE” (product name) manufactured by Kato Tech Co., Ltd. The MIU value (average friction coefficient) is an index of slip resistance, and the higher the value, the less slippery the surface is.

### <Measurement of Dureau Hardness (D Type)>

Measurement was performed using the molded article (1) in accordance with JIS K7215.

### <Measurement of Flexural Modulus>

Measurement was performed using the molded article (2) at 23° C. in accordance with ISO178. The unit is “MPa”.

### <Measurement of Total Light Transmittance>

Measurement was performed using the molded article (1) in accordance with JIS K7361.

### <Measurement of Haze (RH Plate)>

The haze of the molded article (1) was measured using a Haze Meter (manufactured by Murakami Color Research Laboratory Co., Ltd.). The lower the haze, the higher the transparency.

### <Production of Thermoplastic Resin Composition for Laser Marking and Evaluation>

The components described in Tables 1A and 1B below were fed into a Henschel mixer in the ratios described in Tables 1A and 1B, and then 0.2 parts of antioxidant “ADEKA STAB (registered trademark) 2112” (tris (2,4-di-tert-butylphenyl) phosphite) manufactured by ADEKA Corporation, 0.2 parts of “IRGANOX (registered trademark) 1010” (tetrakis [methylene 3-(3,5-di-tert-butyl-4-hydroxyphenyl) propionate] methane) manufactured by Ciba Specialty Chemicals, and 0.05 parts of carbon black having a particle diameter of 50 nm (product name “RCF #20”, manufactured by Mitsubishi Chemical Corporation) were added to 100 parts of the total of the components and mixed at 25° C. Next, this mixture was fed to a twin-screw extruder (model name “BT40”, manufactured by Research Laboratory of Plastics Technology Co., Ltd.) and melt-kneaded to obtain pellets of a thermoplastic resin composition for laser marking.

The cylinder temperature during melt-kneading was set to 180° C. to 220° C.

### <Evaluation of Laser Marking Properties>

The obtained pellets were introduced into an injection molding machine (model name “EC60”, manufactured by Toshiba Machine Co., Ltd.) or an injection molding machine (model name “J35AD”, manufactured by Japan Steel Works, Ltd.), and plate-shaped test pieces (80 mm×55 mm×2.4 mm) were molded at a cylinder temperature setting of 180° C. to 240° C.

The surface of this plate-shaped test piece was irradiated with a diode-excited laser marker (model name “RSM30D”, manufactured by Rofin Baasel) under conditions of a scanning speed (printing speed) of 400 mm/s, a wavelength of 1,064 nm, a frequency of 5,500 Hz, a current of 28 A, and a power of 30 W to mark white letter derived from the resin.

The color development (clarity and visibility) of the irradiated area was judged according to the following criteria. The results are shown in Tables 1A and 1B.
“⊚”: Very satisfactorily good (both clarity and visibility are very good)
“∘”: Satisfactorily good (both clarity and visibility are good and there are no problems in practical use)
“Δ”: Good (either clarity or visibility is poor)
“x”: Poor (both clarity and visibility are poor)

TABLE 1A

| | | | | Dureau | MMA | Exam- | Exam- | Exam- | Exam- | Exam- | Exam- |
|---|---|---|---|---|---|---|---|---|---|---|---|
| | | | | hardness | content | ple | ple | ple | ple | ple | ple |
| | | | Type | (A type) | (%) | 1 | 2 | 3 | 4 | 5 | 6 |
| Thermoplastic | Acrylic | Rubber- | MABS | 90 or more | 39 | 70.0 | | | | | 50.3 |
| resin | component- | containing graft | ASA | 90 or more | 0 | | 60.3 | 70.4 | | | |
| composition | containing | copolymer (a1) | MASA | 90 or more | 19 | | | | 10.5 | 50.0 | |
| proportion | reinforced | | ABS | 90 or more | 0 | | | | 42.1 | | |
| (parts) | resin (A) | (Co)polymer | AS | — | 0 | | | | | | |
| | | (a2) | MAS | — | 71 | | 9.5 | 9.5 | 15.8 | 5.0 | |
| | | | PMMA | — | 99.5 | | | | | | 29.6 |

| | | | | | | | | | |
|---|---|---|---|---|---|---|---|---|---|
| Soft elastomer | Parapet | 70 | 34 | | | 20.1 | | 40.0 | |
| (B) | SEBS | 49 | 0 | 30.0 | 30.2 | | 31.6 | 5.0 | 20.1 |

| MMA content (%) in acrylic component-containing reinforced resin (A) | | | | 39.0 | 9.7 | 8.5 | 19.3 | 23.7 | 61.4 |
|---|---|---|---|---|---|---|---|---|---|
| MMA content (%) in 100% of components (A) and (B): X (%) | | | | 27.3 | 6.8 | 13.6 | 13.2 | 26.7 | 49.1 |
| Component (B) content (%) in 100% of components (A) and (B): Y (%) | | | | 30.0 | 30.2 | 20.1 | 31.6 | 45.0 | 20.1 |
| Y/(X + Y) | | | | 0.5 | 0.8 | 0.6 | 0.7 | 0.6 | 0.3 |
| Rubber-like polymer (a1-1) content (%) in 100% of components (A) and (B) | | | | 31.5 | 30.8 | 35.9 | 30.5 | 25.0 | 22.6 |
| Evaluation | Laser marking properties | | | ⊚ | ◯ | ⊚ | ⊚ | ⊚ | ⊚ |
| results | Softness | Grip feeling | Average friction | 0.8 | 0.7 | 0.5 | 0.7 | 0.6 | 0.4 |
| | | Softness | coefficient (MIU) | | | | | | |
| | | | Dureau hardness (D type) | 40 | 50 | 55 | 55 | 53 | 60 |
| | | | Flexural modulus (MPa) | 350 | 450 | 700 | 650 | 440 | 850 |

| | | | | | | | |
|---|---|---|---|---|---|---|---|
| Optical properties | Total light transmittance (%) | 80 | 70 | 71 | 35 | 53 | 80 |
| | Haze | 60 | 60 | 60 | 85 | 68 | 40 |

TABLE 1B

| | | | | | | | | | Com- | Com- | Com- | Com- |
|---|---|---|---|---|---|---|---|---|---|---|---|---|
| | | | | | | | | | parative | parative | parative | parative |
| | | | | Dureau | MMA | Exam- | Exam- | Exam- | Exam- | Exam- | Exam- | Exam- |
| | | | | hardness | content | ple | ple | ple | ple | ple | ple | ple |
| | | | Type | (A type) | (%) | 7 | 8 | 9 | 1 | 2 | 3 | 4 |
| Thermoplastic | Acrylic | Rubber- | MABS | 90 or more | 39 | 66.3 | 25.0 | | | | 30.0 | 30.0 |
| resin | component- | containing graft | ASA | 90 or more | 0 | | | | | | | |
| composition | containing | copolymer | MASA | 90 or more | 19 | | | | | 10.5 | | |
| proportion | reinforced | (a1) | ABS | 90 or more | 0 | | | 60.0 | 52.6 | 42.1 | 10.0 | 10.0 |
| (parts) | resin (A) | (Co)polymer | AS | — | 0 | | | | 15.8 | 15.8 | 10.0 | 5.0 |
| | | (a2) | MAS | — | 71 | 3.5 | 20.5 | 5.0 | | | 50.0 | 50.0 |
| | | | PMMA | — | 99.5 | | 35.0 | 5.0 | | | | |

| | | | | | | | | | |
|---|---|---|---|---|---|---|---|---|---|
| Soft elastomer (B) | Soft acrylic | 70 | 34 | | 19.5 | | | | 5.0 |
| | resin | | | | | | | | |
| | SEBS | 49 | 0 | 30.2 | | 30.0 | 31.6 | 31.8 | |

| MMA content (%) in acrylic component-containing reinforced resin (A) | | | | 40.6 | 73.5 | 12.2 | 0.0 | 2.9 | 47.2 | 49.7 |
|---|---|---|---|---|---|---|---|---|---|---|
| MMA content (%) in 100% of components (A) and (B): X (%) | | | | 28.4 | 65.8 | 8.5 | 0.0 | 2.0 | 47.2 | 48.9 |
| Component (B) content (%) in 100% of components (A) and (B): Y (%) | | | | 30.2 | 19.5 | 30.0 | 31.6 | 31.8 | 0.0 | 5.0 |
| Y/(X + Y) | | | | 0.5 | 0.2 | 0.8 | 1.0 | 0.9 | 0.0 | 0.1 |
| Rubber-like polymer (a1-1) content (%) in 100% of components (A) and (B) | | | | 29.8 | 11.3 | 36.0 | 31.6 | 30.5 | 19.5 | 19.5 |
| Evaluation | Laser marking properties | | | ⊚ | ⊚ | ◯ | X | X | ⊚ | ⊚ |
| results | Softness | Grip feeling | Average friction | 0.8 | 0.3 | 0.7 | 0.7 | 0.7 | 0.2 | 0.2 |
| | | | coefficient (MIU) | | | | | | | |
| | | Softness | Dureau hardness (D type) | 46 | 85 | 44 | 46 | 47 | 81 | 81 |
| | | | Flexural modulus (MPa) | 390 | 1900 | 300 | 350 | 400 | 2400 | 2200 |

| | | | | | | | | |
|---|---|---|---|---|---|---|---|---|
| Optical | Total light transmittance (%) | 74 | 88 | Opaque | Opaque | Opaque | 85 | 80 |
| properties | Haze | 88 | 25 | 99 or | 99 or | 99 or | 30 | 35 |
| | | | | more | more | more | | |

The following can be seen from Tables 1A and 1B above.

Examples 1 to 9 using the thermoplastic resin composition of the present invention are not only excellent in laser marking properties, but also have excellent in softness, tactile feel (grip feeling), slip resistance (MIU value), and optical properties. In contrast, Comparative Examples 1 to 4, which do not satisfy the condition of formula (1), do not achieve both laser marking properties and tactile performance.

Although the present invention has been described in detail by way of the specific modes, it is apparent for those skilled in the art that various changes can be made without departing from the spirit and scope of the present invention.

The present application is based on Japanese Patent Application No. 2022-126425 filed on Aug. 8, 2022, the entire contents of which are incorporated herein by reference.

### INDUSTRIAL APPLICABILITY

The molded article of the present invention using the thermoplastic resin composition of the present invention has excellent laser marking properties, a non-slippery surface, and a good tactile feel such as grip feeling. Therefore, it can be suitably used as an article which has to be manually operated or be prevented from readily slipping out of a hand, and is capable of providing an article having slip resistance, and high grip performance. Further, the thermoplastic resin molded article serves not only as a grip to be held by hand, but also as a member of a ground surface of a personal computer, a printer, or the like so as to enable a non-slip effect to be realized. For these reasons, the usefulness of the molded article of the present invention is extremely high.

1. A thermoplastic resin composition comprising a component (A) and a component (B) identified below,
wherein, when a content of methyl methacrylate units is expressed as X % by mass and a content of the component (B) is expressed as Y % by mass, based on 100% by mass of a total of the component (A) and the component (B), a formula (1) identified below is satisfied.
$$0.1 < Y / ( X + Y ) < 0.9 \qquad ( 1 )$$
Component (A): An acrylic component-containing reinforced resin comprising a rubber-containing graft copolymer (a1) having a Dureau hardness (A type) of 90 or more; or an acrylic component-containing reinforced resin comprising the rubber-containing graft copolymer (a1) and a (co)polymer (a2) not containing a rubbery polymer, wherein a methyl methacrylate unit is contained in the rubber-containing graft copolymer (a1) and/or the (co)polymer (a2)
Component (B): A soft elastomer having a Dureau hardness (A type) of less than 90

2. The thermoplastic resin composition according to claim 1, wherein the content Y of the component (B) based on 100% by mass of the total of the component (A) and the component (B) is more than 20.0% by mass.

3. The thermoplastic resin composition according to claim 1, wherein the rubber-containing graft copolymer (a1) is at least one selected from the group consisting of methyl methacrylate-acrylonitrile-butadiene-styrene graft copolymer, acrylonitrile-styrene-acrylic rubber graft copolymer, methyl methacrylate-acrylonitrile-styrene-acrylic rubber graft copolymer, and acrylonitrile-butadiene-styrene graft copolymer.

4. The thermoplastic resin composition according to claim 1, wherein the thermoplastic resin composition is a thermoplastic resin composition for laser marking.

5. A molded article obtained by molding the thermoplastic resin composition according to claim 1.

6. An article obtained by laser marking the surface of the molded article according to claim 5.
